(19) United States
(12) Patent Application Publication
(10) Pub. No.: US 2006/0288732 A1
(43) Pub. Date: Dec. 28, 2006

(54) Refrigeration cycle

(75) Inventors: Syunji Komatsu, Isesaki-shi (JP); Kiyokazu Yamamoto, Isesaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANDEN CORPORATION, Isesaki-shi (JP)

(21) Appl. No.: 11/510,724

(22) Filed: Aug. 28, 2006

Related U.S. Application Data
(63) Continuation of application No. 11/207,720, filed on Aug. 22, 2005.
Application No. 11/207,720 is a continuation of application No. PCT/JP04/02329, filed on Feb. 26, 2004.

(30) Foreign Application Priority Data
Jun. 2, 2003 (JP) JP 2003-156609

(51) Int. Cl. C09K 5/04; F25B 41/04; F25B 1/00

(52) U.S. Cl. 62/498; 62/222; 62/114

(57) ABSTRACT

It is an object of the invention to provide a refrigeration cycle which uses HFC-152a as refrigerant, and can be operated stably without hunting of the superheat degree. A charge amount of refrigerant is increased, and refrigerant at an inlet of an expansion device is placed in a state where the subcool degree is ensured to be at least 5 degrees such that the subcool degree does not become equal to zero by variation in pressure. This suppresses fluctuation in the superheat degree of refrigerant at an outlet of an evaporator to thereby stabilize the system. In this state, to enhance the efficiency of a compressor, the superheat degree can be increased by decreasing the set value of the expansion device.

This application is a continuation application of U.S. application Ser. No. 11/207,720, filed Aug. 22, 2005, which is a continuation of International Application PCT/JP2004/002329, filed Feb. 26, 2004.

### BACKGROUND OF THE INVENTION

1. Field of the Invention

This invention relates to a refrigeration cycle, and more particularly to a refrigeration cycle using HFC-152a as refrigerant.

2. Description of the Related Art

A refrigeration cycle for an automotive air conditioning system, for example, comprises a compressor that is driven by an engine as a drive source, a condenser that condenses refrigerant compressed by the compressor, a receiver that separates the condensed refrigerant into a gas and a liquid, an expansion device that throttles and expands the liquid refrigerant obtained by gas/liquid separation, and an evaporator that evaporates the expanded refrigerant to return the same to the compressor.

In the refrigeration cycle configured as above, to enhance the efficiency of the compressor, it is a common practice to provide control such that refrigerant at the outlet of the evaporator has a predetermined degree of superheat. Further, in a refrigeration cycle that carries out control of the degree of superheat, refrigerant at the inlet of the expansion device is controlled such that the refrigerant has no degree of subcool. In this case, it is also known to further cool refrigerant delivered from the receiver such that the refrigerant presents a degree of subcool so as to improve efficiency of the compressor (see e.g. Japanese Unexamined Patent Publication (Kokai) No. H06-2970 (Paragraph numbers [0006] and [0007], and FIG. 4).

In the conventional refrigeration system, in general, a CFC substitute called HFC-134a is generally used as refrigerant.

FIG. 8 is a diagram showing characteristics of a refrigeration cycle using HFC-134a as refrigerant.

In FIG. 8, there are shown temporal changes in the subcool degree SC, the superheat degree SH, and the flow rate Gf of HFC-134a as refrigerant. As is apparent from FIG. 8, in the case of HFC-134a being used as refrigerant, the ranges of fluctuation in the superheat degree SH and the flow rate Gf are small even when the subcool degree SC assumes a small value of approximately 1, and therefore the hunting of the superheat degree SH is small, which means that the system is substantially stable.

However, when HFC-134a is used as refrigerant for the refrigeration cycle, it has a significant influence on the global warming, and hence alternatives to HFC-134a have been studied. One of the alternatives being studied is refrigerant called HFC-152a, whose influence on the global warming is approximately one tenth of the influence of HFC-134a.

FIG. 9 is a diagram showing characteristics of a refrigeration cycle using HFC-152a as refrigerant.

FIG. 9 shows a case in which HFC-152a is used as refrigerant, the charge amount of which is set to 500 g, and an expansion valve, whose set value is set to 0.177 MPa, is used as the expansion device. In this case, it is known that the superheat degree SH and the subcool degree SC are stable at approximately 2 degrees and approximately 1 degree, respectively, and the hunting tends to be small in a region where the superheat degree SH is small. However, when the superheat degree SH is as small as approximately 2 degrees, the efficiency of the compressor is degraded, and hence, it is preferable that the superheat degree SH is increased to approximately 10 degrees.

However, when HFC-152a is used as refrigerant, if the set value of the expansion valve is decreased so as to increase the superheat degree SH, as shown in FIG. 9, the superheat degree SH is increased, but the range of fluctuation in the superheat degree SH is also increased to cause the hunting, which makes the system unstable.

### SUMMARY OF THE INVENTION

The present invention has been made in view of the above points, and an object thereof is to provide a refrigeration cycle which can be operated stably without hunting of a superheat degree SH.

To solve the above problem, the present invention provides a refrigeration cycle comprising a compressor, a condenser, an expansion device, and an evaporator, and using HFC-152a as refrigerant circulating therethrough, wherein the refrigerant at an inlet of the expansion device is necessarily placed in a state where a predetermined degree of subcool is ensured, whereby fluctuation in a degree of superheat of the refrigerant at an outlet of the evaporator is suppressed, for stabilization.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram showing characteristics of a refrigeration cycle using HFC-152a as refrigerant.

FIG. 2 a diagram showing a flow rate characteristic of HFC-152a as refrigerant.

FIG. 3 is a diagram showing part of a Mollier chart.

FIG. 4 is a diagram showing a method of improving the degree of superheat.

FIG. 5 is a system diagram showing a refrigeration cycle using a receiver.

FIG. 6 is a system diagram showing a refrigeration cycle using a subcool condenser.

FIG. 7 is a system diagram showing a refrigeration cycle using an accumulator.

FIG. 8 is a diagram showing characteristics of a refrigeration cycle using HFC-134a as refrigerant.

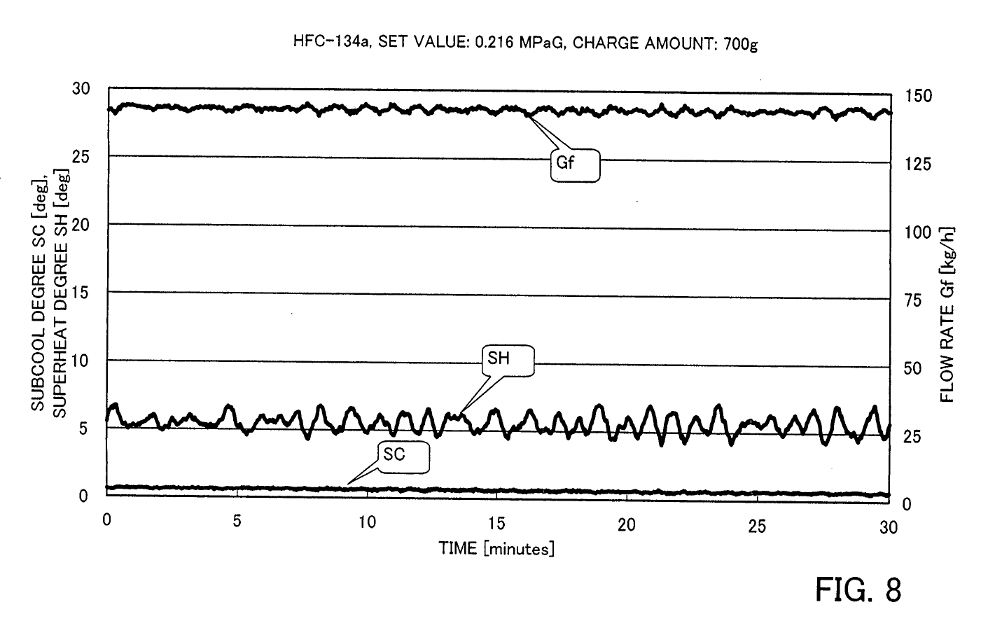

FIG. 9 is a diagram showing characteristics of a refrigeration cycle using HFC-152a as refrigerant.

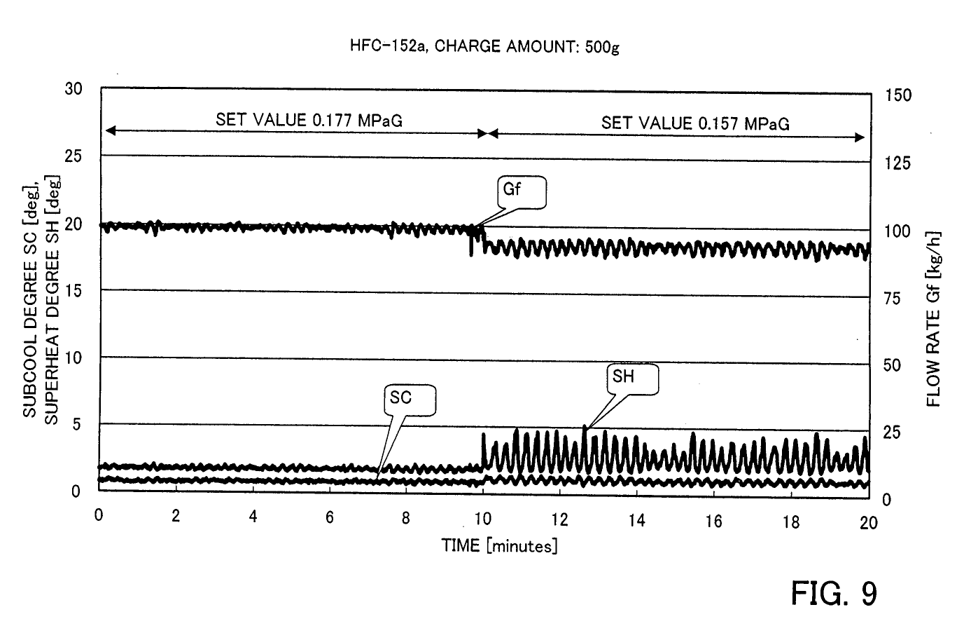

### DESCRIPTION OF THE PREFERRED EMBODIMENTS

Hereinafter, an embodiment of the present invention will be described in detail by taking a case where it is applied to a refrigeration cycle for an automotive air conditioning system, as an example.

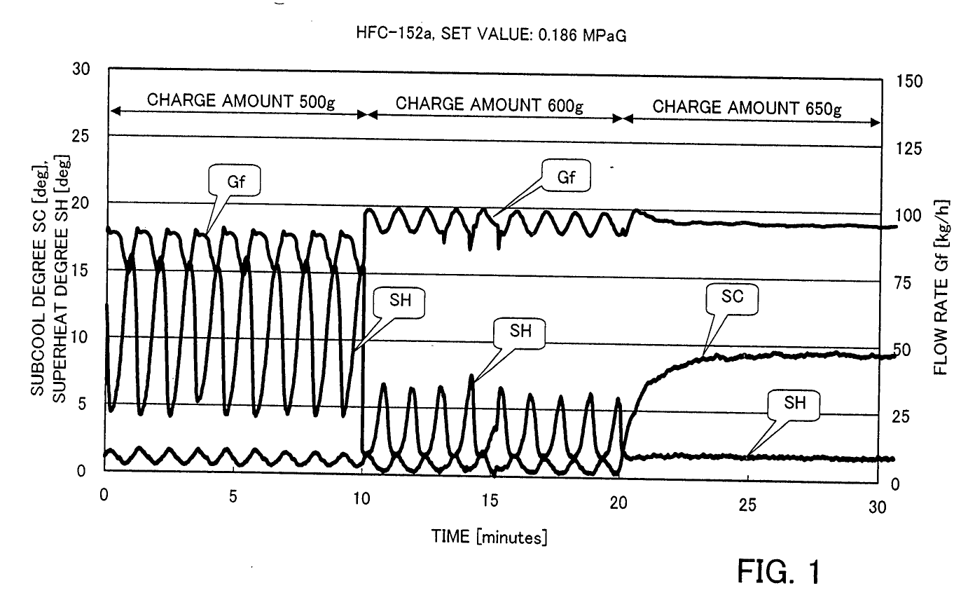

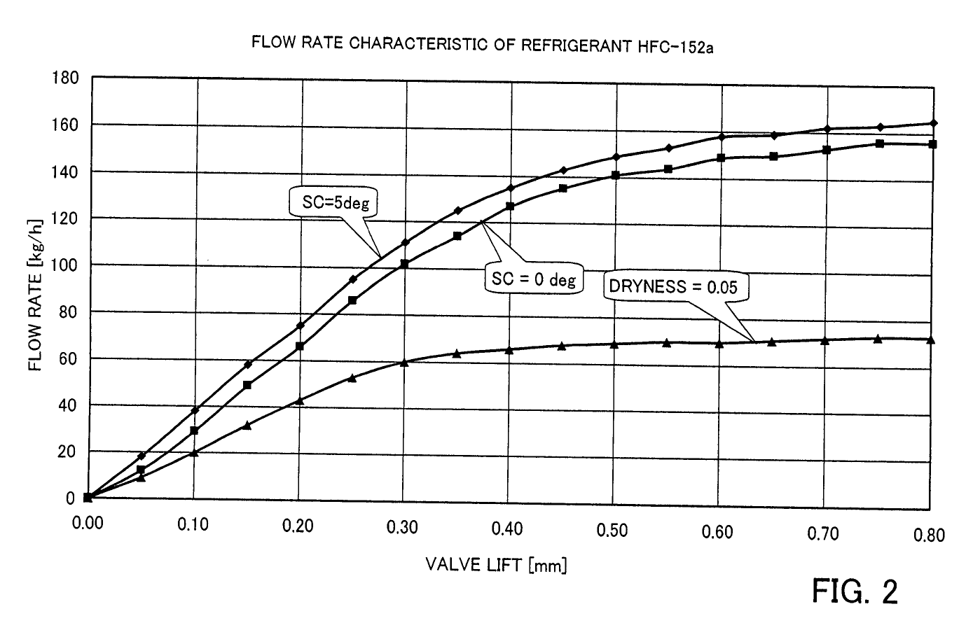

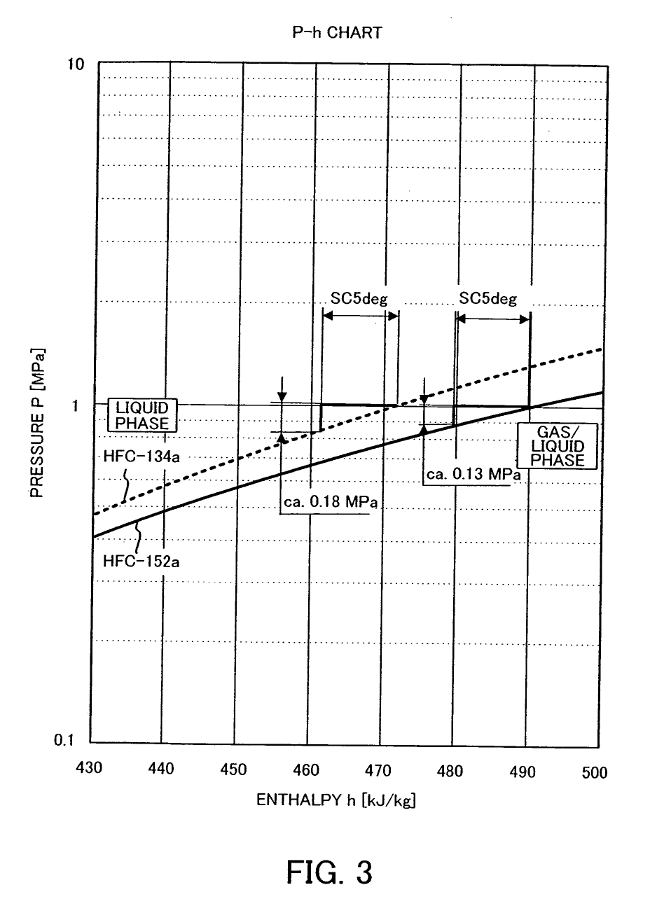

FIG. 1 is a diagram showing characteristics of a refrigeration cycle using HFC-152a as refrigerant; FIG. 2 is a diagram showing a flow rate characteristic of HFC-152a as refrigerant; and FIG. 3 is a diagram showing part of a Mollier chart.

First, FIG. 1 shows temporal changes in the subcool degree SC, the superheat degree SH, and the flow rate Gf, of HFC-152a as refrigerant, obtained when an expansion valve which is set to 0.186 MPa as a set point is employed as an expansion device.

It is understood from FIG. 1 that when the charge amount of the refrigerant is set to 500 g, the superheat degree SH is not less than 3 degrees, but the range of fluctuation in the superheat degree SH is large, causing hunting thereof. It is also understood that to prevent the hunting of the superheat degree SH, if the charge amount of the refrigerant is increased to 600 g, and further to 650 g to impart a subcool degree SC to the refrigerant, the superheat degree SH largely fluctuates to make the system unstable in a region where the subcool degree SC is only approximately 1 or 2 degrees, whereas in a region where the subcool degree SC is not less than 5 degrees, the fluctuation in the superheat degree SH is small, and the system becomes stabile. Therefore, in the refrigeration cycle using HFC-152a as refrigerant, it is absolutely essential that refrigerant at the inlet of the expansion valve is placed in a subcooled state, and if the subcool degree SC is ensured to be at least 5 degrees, it is possible to prevent hunting of the superheat degree SH whereby the system is made stable.

It is presumed that the above tendency is due to the fact that HFC-152a has a more readily vaporizable property than that of HFC-134a. The flow rate characteristic of HFC-152a shown in FIG. 2 indicates changes in the flow rate of refrigerant with respect to the valve lift of the expansion valve. From this, it is understood that the flow rate of refrigerant does not largely change even when the subcool degree SC is reduced from 5 degrees to zero. However, when the refrigerant has even a slight degree of dryness, air bubbles come to be mixed in the refrigerant flowing into the expansion valve. This makes it difficult for the refrigerant to flow smoothly, resulting in a sudden decrease in the flow rate of the refrigerant.

Further, as is apparent from FIG. 1, it is preferable that the subcool degree SC is not less than 5 degrees. The reason for this will be explained with reference to FIG. 3. In FIG. 3, a broken line indicates a saturation liquid line of the conventional HFC-134a, and a solid line indicates a saturation liquid line of HFC-152a. As shown in FIG. 3, the slopes of the saturation liquid lines of HFC-134a and HFC-152a are different from each other, and the saturation liquid line of HFC-152a has a gentler slope. Therefore, even if HFC-134a and HFC-152a have the same subcool degree SC of 5 degrees, HFC-152a enters a gas/liquid phase by a smaller change in pressure. In the examples illustrated in FIG. 3, although HFC-134a does not enter the gas/liquid phase without a change in pressure of approximately 0.18 MPa, HFC-152a enters the gas/liquid phase when the pressure undergoes a change of approximately 0.13 MPa. Accordingly, it is necessary to positively place refrigerant flowing into the expansion valve in a subcooled state when the subcool degree SC is not less than 5 degrees, to thereby prevent the refrigerant from easily entering the gas/liquid phase even when the pressure of refrigerant undergoes a certain amount of change. As is apparent from the above, in the refrigeration cycle using HFC-152a as refrigerant, if the subcool degree SC is not imparted to the refrigerant, the refrigerant easily enters the gas/liquid phase even by a slight change in pressure, and once the refrigerant has entered the gas/liquid phase, the flow rate thereof sharply drops. Therefore, it is necessary to impart the subcool degree SC to the refrigerant sufficiently compared with a refrigeration cycle using HFC-134a as refrigerant. This is why in the refrigeration cycle using HFC-152a as refrigerant, the refrigerant at the inlet of the expansion valve is required to be always placed in the subcooled state, and moreover, in order to cause the system to perform stable operation irrespective of variations in pressure, the subcool degree SC is required to be not less than 5 degrees.

As described above, in the refrigeration cycle using HFC-152a as refrigerant, the subcool degree SC is necessarily required to be not less than 5 degrees. This subcool degree SC makes it possible to suppress fluctuation in the superheat degree SH, which makes the system stable. However, under the conditions shown in FIG. 1, although the superheat degree SH is stable without hunting, only 2 degrees of the superheat degree SH is obtained. To enhance the efficiency of the compressor, it is preferable that the superheat degree SH is equal to approximately 10 degrees.

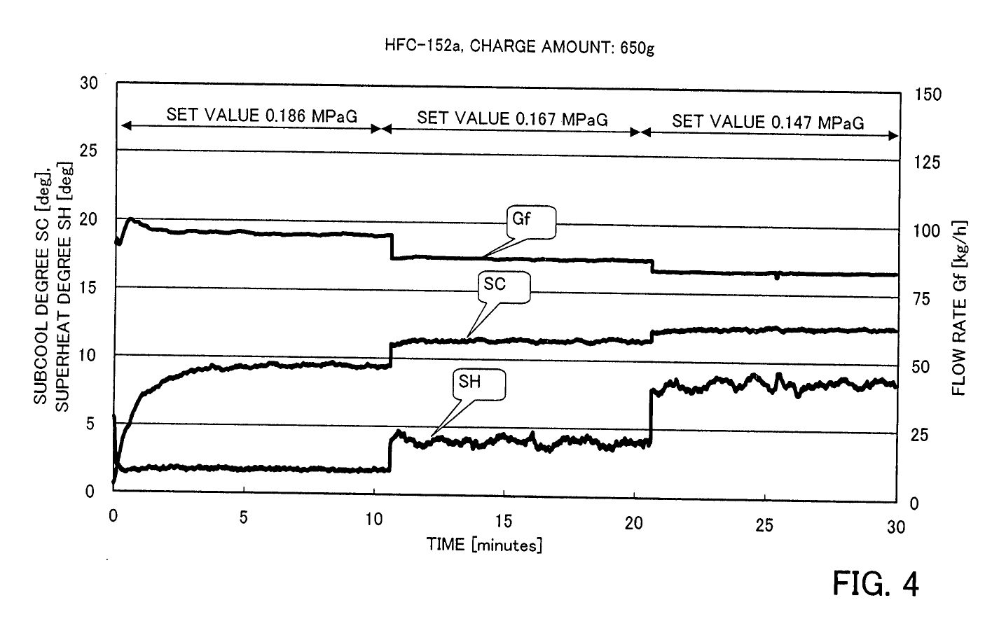

FIG. 4 is a diagram showing a method of improving the degree of superheat.

As shown in FIG. 4, the superheat degree SH is improved by progressively decreasing the set value of the expansion valve. From the illustrated example, it is understood that if the charge amount of the refrigerant is set to 650 g, and the set value of the expansion valve is decreased from 0.186 MPa to 0.167 MPa, and further to 0.147 MPa, the superheat degree SH increases, and moreover that the superheat degree SH is stable without hunting even, when it increases.

This is because by decreasing the set value of the expansion valve, the flow rate of refrigerant passing through the expansion valve is reduced to relatively increase the capability of an evaporator. If the refrigerant is further heated after being completely evaporated by the evaporator, it is possible to place the refrigerant at the outlet of the evaporator in a sufficiently superheated state. Of course, the reduction of the flow rate of refrigerant entering the expansion valve relatively increases the capability of the condenser, so that as the superheat degree SH increases, the subcool degree SC as well increases.

Next, a description will be given of a refrigeration cycle which uses HFC-152a as refrigerant, and causes the subcool degree SC of HFC-152a to be not less than 5 degrees, for stabilization.

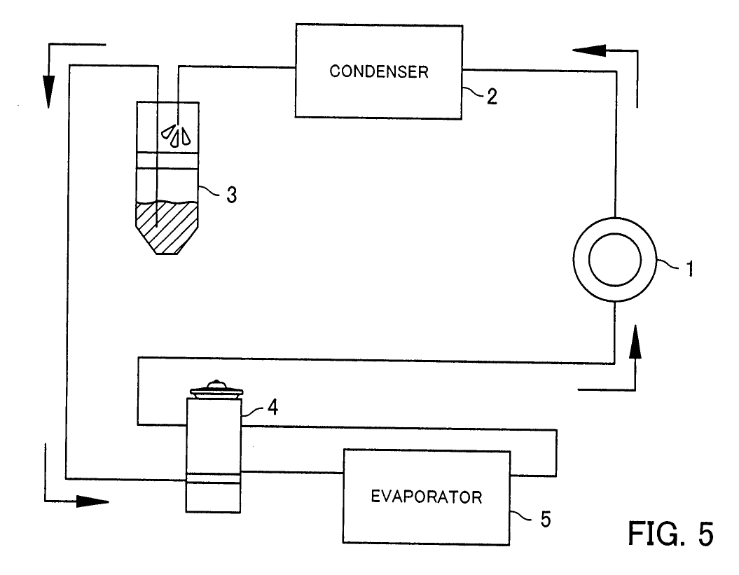

FIG. 5 is a system diagram showing a refrigeration cycle using a receiver.

This refrigeration cycle comprises a compressor 1, a condenser 2, the receiver 3, a thermostatic expansion valve 4, and an evaporator 5, and configured such that the refrigerant of HFC-152a circulates therethrough. The compressor 1 is driven by an engine as a drive source, for compressing the refrigerant. The refrigerant compressed by the compressor 1 to high-temperature, high-pressure refrigerant is condensed by the condenser 2 to be changed into high-temperature, high-pressure liquid refrigerant. The liquid refrigerant is separated into a gas and a liquid by the receiver 3, and the liquid refrigerant obtained by gas/liquid separation is throttled and expanded by the thermostatic expansion valve 4, for being changed into atomized low-temperature, low-pressure refrigerant. The refrigerant having flown out from the thermostatic expansion valve 4 is evaporated to be gasified by the evaporator 5. The gasified refrigerant is caused to pass through a portion of the thermostatic expansion valve 4 for sensing the temperature and the pressure of the refrigerant, and returned to the compressor 1. At this time, the thermostatic expansion valve 4 senses the temperature and the pressure of refrigerant at the outlet of the evaporator 5, and controls the flow rate of refrigerant to be delivered to the evaporator 5 such that the refrigerant at the outlet of the evaporator 5 maintains a predetermined superheat degree SH.

In the above refrigeration cycle, by overcharging the refrigerant, the subcool degree SC at the inlet of the thermostatic expansion valve 4 is ensured. Further, the subcool degree SC can be also ensured by increasing the cooling capacity of the condenser 2 e.g. by increasing the number of fans provided thereon. Furthermore, it is more effective in ensuring the subcool degree SC, to reduce pressure loss in piping from the receiver 3 to the thermostatic expansion valve 4 e.g. by integrally forming the receiver 3 and the thermostatic expansion valve 4 with each other, or by thickening and shortening the piping between the receiver 3 and the thermostatic expansion valve 4.

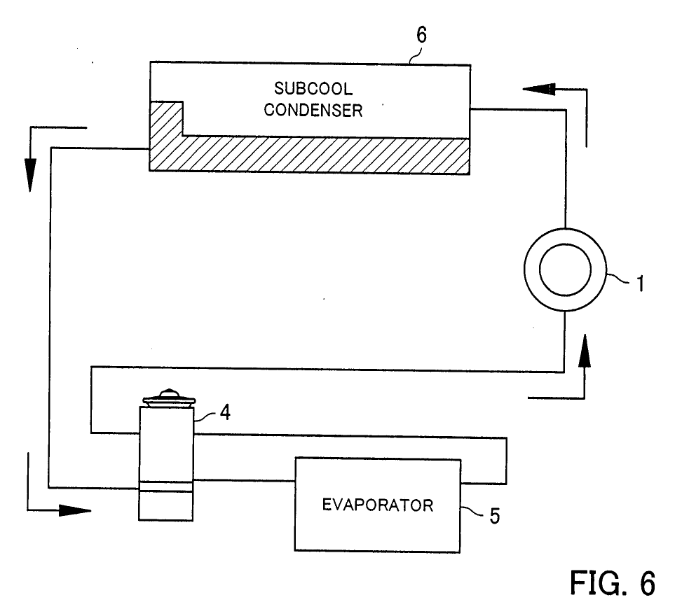

FIG. 6 is a system diagram showing a refrigeration cycle using a subcool condenser.

This refrigeration cycle comprises the compressor 1, a subcool condenser 6, the thermostatic expansion valve 4, and the evaporator 5, and is configured such that the refrigerant of HFC-152a circulates therethrough. The subcool condenser 6, which is provided with the function of a receiver, cools refrigerant delivered from the compressor 1 for complete liquefaction, and further cools the liquefied refrigerant for delivery to the thermostatic expansion valve 4. Therefore, the refrigerant delivered from the subcool condenser 6 already has a predetermined subcool degree SC imparted thereto, so that it is possible to positively ensure the subcool degree SC by the subcool condenser 6.

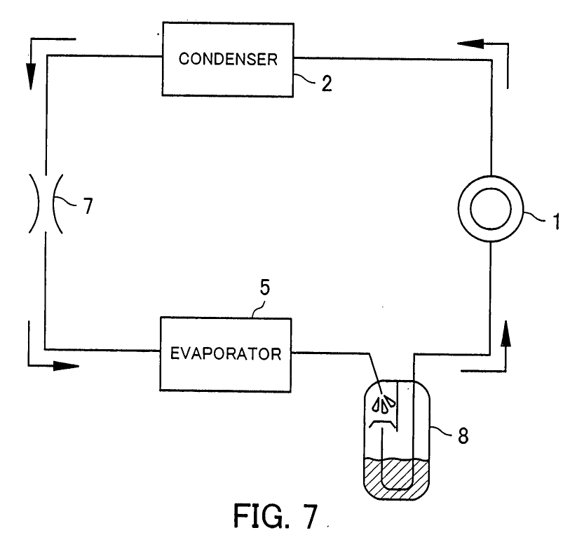

FIG. 7 is a system diagram showing a refrigeration cycle using an accumulator.

This refrigeration cycle comprises the compressor 1, the condenser 2, an orifice tube 7, the evaporator 5, and an accumulator 8, and is configured such that the refrigerant of HFC-152a circulates therethrough. In this refrigeration cycle as well, the refrigerant is overcharged, whereby it is possible to suppress the hunting of the superheat degree SH of refrigerant at the outlet of the evaporator 5.

It should be noted that in the refrigeration cycle which uses HFC-152a as refrigerant having a smaller slope of the saturation liquid line than that of the saturation liquid line of HFC-134a, to prevent the refrigerant from entering the gas/liquid phase easily by a slight change in pressure, it is required to always place the refrigerant at the inlet of the expansion device in the subcooled state, and hence as a matter of course, the present invention can be applied to refrigeration cycles which use a refrigerant having a similar tendency to HFC-152a in the slope of a saturation liquid line thereof, thereby suppressing fluctuation in the superheat degree SH of refrigerant, which makes it possible to stabilize the system.

As described above, the refrigeration cycle according to the present invention is configured such that refrigerant at the inlet of the expansion device is always placed in the subcooled state, and that the subcool degree SC is ensured to be at least 5 degrees so as to prevent the subcool degree SC from becoming equal to zero by variation in pressure. In the refrigeration cycle using the conventional refrigerant, the system is stable since no hunting of the superheat degree SH is caused irrespective of whether or not the refrigerant has the subcool degree SC, whereas in the refrigeration cycle using HFC-152a as refrigerant, the hunting of the superheat degree SH is liable to occur in the state where the refrigerant has no subcool degree SC, and hence by causing the refrigerant to be always cooled such that it has the subcool degree SC, it is possible to suppress the hunting of the superheat degree SH, thereby making it possible to stabilize the system.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A method of operating a refrigeration cycle comprising the steps of:
circulating HFC-152a refrigerant through a compressor, a condenser, an expansion device, and an evaporator; and
ensuring a predetermined degree of subcool of the HFC-152a refrigerant at an inlet of the expansion device, whereby fluctuation in a degree of superheat of the refrigerant at an outlet of the evaporator is suppressed providing stabilization.

2. The method of operating a refrigeration cycle according to claim 1, wherein the degree of subcool is ensured to be at least 5 degrees.

3. The method of operating a refrigeration cycle according to claim 1, wherein a charge amount of the refrigerant is adjusted to ensure the degree of subcool.

4. The method of operating a refrigeration cycle according to claim 1, wherein the condenser is replaced by a subcool condenser to thereby ensure the degree of superheat.

5. The method of operating a refrigeration cycle according to claim 1, wherein the expansion device is replaced by a thermostatic expansion valve, and a set value of the thermostatic expansion valve is adjusted to provide the degree of subcool.
